(19) United States
(12) Patent Application Publication
(10) Pub. No.: US 2004/0237628 A1
(43) Pub. Date: Dec. 2, 2004

(54) Method for operating a circuit arrangement containing a microcontroller and an eeprom

(76) Inventor: Alexander Steinert, Tuebingen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/488,719

(22) PCT Filed: Aug. 21, 2002
(86) PCT No.: PCT/DE02/03051

(30) Foreign Application Priority Data
Sep. 4, 2001 (DE) 101 43 142.2

(51) Int. Cl. G01N 7/00

(52) U.S. Cl. 73/31.01

(57) ABSTRACT

The invention relates to a method for operating a circuit arrangement containing a microcontroller (10) and an EEP-ROM (11). A first memory area (39) having at least one data set memory (DA1, DA2, DA3) and at least one second memory area (30) also having at least one data set memory (DB1, DB2, DB3) are provided in the EEPROM (11). A pointer (P1, P2, P3) located in a third memory area (31) refers to the respectively valid memory area (29, 30). In one step (53), the microcontroller (10) stores a data set in the invalid memory area (29, 30) and, in a subsequent step (54), changes the pointer (P1, P2, P3) so that the invalid memory area (29, 30) becomes the valid memory area (30, 29). Both steps (53, 54) are cyclically repeated. In the event of a fault during a storage process, a correct data set is available at all times in the memory area (29, 30) indicated as being valid.

### STATE OF THE ART

The invention starts out from a method of operating a circuit arrangement containing a microcontroller and an EEPROM [electrically erasable programmable read only memory] of the type set forth in the independent claim. From DE-A 197 16 520 a method of this type has become known in which the operating parameters of electric motors are detected. Especially the operating duration [operating hours] is stored in memory. For long-term storage, a PROM [programmable read only memory], an EPROM [erasable programmable read only memory] or an EEPROM [electrically erasable programmable read only memory] can be provided.

With a PROM, the data set to be recorded is stored by irreversible programming of the PROM memory cells. An EPROM can, by erasure of the memory content at the end of the use cycle be reused. Since both storage types allow the storage of a data set in the same memory cells only once during a use cycle, numerous memory cells must be reserved for an operating duration counter.

The most flexible solution provides an EEPROM whose memory cells can be electrically written to and erased. The advantages of the use of an EEPROM are, however, associated also with drawbacks. The EEPROM can transition into an undefined operating state when during a storage process the operating voltage should fail. The result is a defectively stored data set.

The invention has as its object the provision of a method of operating a circuit arrangement which contains a microcontroller and an EEPROM in which the EEPROM reliably stores the data sets.

This object is achieved with the features given in the independent claim.

### Advantages Of The Invention

The method of the invention proposes initially that in the EEPROM there be a first memory region and at least one second memory region for the storage of at least one data set. Furthermore, a third memory region is provided which contains a pointer which indicates the memory region in force or which is effective. The microcontroller stores in a first step a data set in the ineffective memory region and varies in a second step a pointer so that the ineffective memory regions is switched to the effective memory region. The two steps are cyclically repeated.

A substantial advantage of the method of the invention resides in that in each memory state an effective data set resides at least in one of the at least two memory regions. A defect in the operating course, especially as can result from a shutdown of the voltage supply during a writing operating and which, as a consequence can result in a defective writing of a data set to one of the memory regions has no effect on the correctly registered data set in the other memory region. As a result one can at any time recover the last-stored data set in the other memory region.

An especially advantageous feature of the invention involves the incorporation of a reset arrangement in the method according to the invention. A recognized disturbance in the course of the program or in the initiation of the operation of the circuit arrangement triggers a reset. According to the invention it is provided that the microcontroller, after a reset, in a first starting step read out the pointer and read out in a second starting step the data set from the effective memory region indicated by the pointer.

The method of the invention is especially suitable for circuit arrangement whose operating voltage can at any time be turned on or shut off by a user. Since the pointer, after a reset, always indicates a stored data set which has been stored in a normal operating state, the further method steps always are capable of presenting a correct data set.

An advantageous refinement of the invention provides that the pointer be realized as a bit pointer. The bit pointer indicates, based upon the lowest value bit, a data set of optional length for example a byte which is in the respective effective memory region. This feature has the advantage that during a change of the memory content of the pointer, should an error occur, for example as a result of an interrupted voltage, the pointer, instead of indicating a correct data set in one memory region will indicate an also correct data set in the other memory region.

Because of the sequential operation of the microcontroller, the possibility that more than one storage process will be defective can be excluded. A correct data set registered in at least a preceding cycle will always be available after a reset for accessing.

According to another advantageous feature, a timer is provided which controls the cyclical repetition of the first and second steps. The timer can be contained in the microcontoller. As a function of the cycling period established by the timer, preferably in the form of a course generator, the timer can trigger the first step in which a data set is stored in the as yet ineffective memory region. In the second step the pointer is changed so that the pointer is switched from the ineffective memory region to the memory region to be effective. This feature has the advantage that independently from the program course in the microcontroller, after a predetermined time the two steps of the method of the invention are effected.

Another advantageous refinement provides that the data set to be stored is incremented or decremented from cycle to cycle. With this feature an operating duration counter can be obtained in a simple manner. The measurement of the operating duration can be based upon the cycling frequency in combination with the timer. The method of the invention thus reliably ensures that there will be no loss in the operating time from a defective storage operation since, as a result of the reset, the stored correct data set in another memory region previously stored is recovered.

The method of the invention is suitable especially for use for devices in a motor vehicle. Because the available electrical energy in a motor vehicle is limited, in the shutoff state of the motor vehicle, it is advantageous if the circuit arrangement can be completely turned off. A defect in the storage of a data set during the shutdown thus has no further effect since, upon return to an operating state, the last correctly stored data set can be accessed. One possible application of the invention in a motor vehicle is as an air quality sensor which detects the quality of the external air and provides a control signal to an air-conditioning unit of the motor vehicle. Based upon the operating time counter, brief or long duration corrections of the sensor signal can be made. Further advantageous features of the method of the invention are given in the additional dependent claims and will be apparent from the following description.

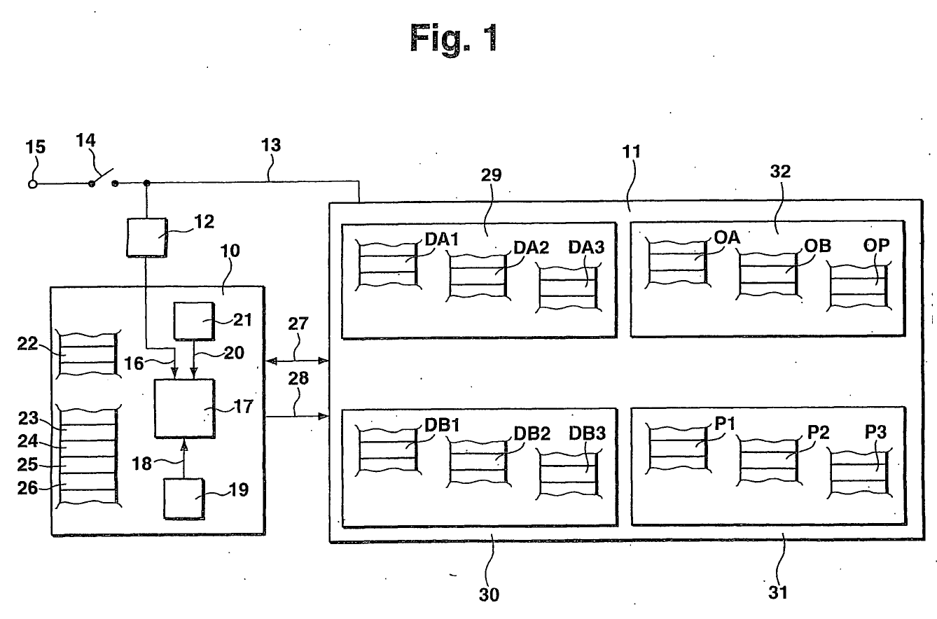

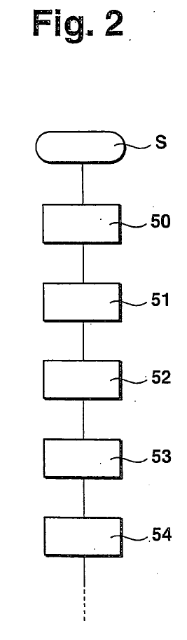

FIG. 1 shows a block circuit diagram of a circuit arrangement in which the method of the invention is carried out according to FIG. 2.

The circuit arrangement includes a microcontroller 10, an EEPROM 11 and a reset arrangement 12. Both the reset arrangement 12 and the EEPROM 11 are connected with a current supply line 13 which is connectable by a switch 14 with an energy source 15.

The reset arrangement 12 issues a reset signal 16 to a processor core 17. The processor core 17 receives further a clock signal 18 provided by a clock generator 19 as well as a timer signal 20 supplied by a timer 21.

The microcontroller 10 includes a reset memory 22, a data set memory 23, a pointer memory 24, a data set offset memory 25 and a pointer offset memory 26.

The microcontroller 10 communicates with the EEPROM 11 by means of a bidirectional data bus 27 as well as through an address bus 28.

The EEPROM 11 contains a first memory region 29, a second memory region 30, a third memory region 31 and a fourth memory region 32. The first memory region 29 contains a first, second and third data set store DA1, DA2, DA3. The second memory region 30 contains as well a first, second and third data stores DB1, DB2, DB3. The third memory region 31 contains a first, second and third pointers P1, P2, P3. The fourth memory region 32 contains a first and a second data offset stores OA, OB as well as a pointer offset store OP.

FIG. 2 shows a method according to the invention in which a start S initiates a reset process in a first starting step 50. In a second starting step 51 a readout of the pointer P1, P2, P3 is provided. In a third starting step 52, a data set is read out either from a first memory region 29 or the second memory region 30 depending upon which memory region 29, 30 is indicated by the pointer P1, P2, P3 as the effective memory region.

In a first step 53, a data set is stored in a data set storage DA1, DA2, DA3 or DB1, DB2, DB3 which lies in the memory region 29, 30 which is the ineffective first or second memory region. In a second step 54, the pointer P1, P2, P3 is changed so that it indicates the effective first or second memory region 29, 30 at this point in time.

The method of the invention for operating the circuit arrangement works as follows:

Initially the current supply line 13 is connected by the switch 14 with energy source 15, for example, a battery. The reset arrangement 12 which is included in the microcontroller, outputs a reset signal 16. The reset signal 16 triggers microcontroller 10 to a fresh start of the program sequence. The information required for a reset is generally a start address and is stored in the reset memory 23. The reset memory 23 is preferably contained in a ROM [read only memory] whose contents are established upon manufacture. The ROM can be contained in the microcontroller 10. After the start S, which is initiated by actuation of the switch 14, the first starting step 50 is carried out and corresponds to the reset procedure.

The microcontroller 10 is connected by data bus 27 and the address bus 28 with the EEPROM 11. The designation “EEPROM” (electrical erasable and programmable memory) is here used for the type of storage which does not lose its contents upon a shutdown of the operating voltage and to whose storage cells the data can be written many times. The EEPROM can be incorporated in the microcontroller 10 which in this case would be designatable as a microprocessor.

In the third memory region 31 of the EEPROMs 11, the pointer P1, P2, P3 is provided. The pointer P1, P2, P3 is a data set which can indicate whether the first or second memory region 29, 30 of the EEPROMs 11 is effective or ineffective. Preferably the pointer P1, P2, P3 is formed as a bit pointer sothat only one bit is required and the state 0 or 1 is used. In the case in which the bit pointer is formed to deal with a byte, the information is preferably coded as the lowest value bit.

Instead of one pointer, in the illustrated embodiment, a first, second and third pointer P1, P2, P3 is shown. Which of the three pointers P1, P2, P3 holds the actual information is given by the data set stored in the pointer offset memory OP which is provided in the fourth memory range 32 of the EEPROMs 11. The microcontroller 10 reaches the appropriate pointer P1, P2, P3 by reading the offset address registered in the pointer offset store OP which preferably is added to an information base address of the microcontroller instead of the three pointers P1, P2, P3 which have been illustrated, further pointers can be included which only distinguish the addresses in the EEPROM 11.

The most important reasons for providing the different pointers P1, P2, P3 is that, for technical reasons, there is a limited amount of data which can be written into the same memory location in the EEPROM 11. The offset in the pointer offset store OP can be varied from one predetermined number of storage processes to another value which is directed to the next pointer P1, P2, P3.

The pointers P1, P2, P3 “wander” to a certain extent through the EEPROM 11. The information as to how many storage processes may occur during operation of the EEPROM 11 is not indicated in greater detail herein.

Advantageously the information as to the number of storage processes which have been undergone can be determined from the data sets stored in the data set stores DA1, DA2, DA3 or DB1, DB2, DB3. This refinement is possible in the framework of an operating time counter in the following manner:

The timing cadence is supplied to the microcontroller 10 by means of the clock generator 19 which preferably is a quartz generator and is registered by the timer 21. A cycling time of for example 10 seconds is enabled by a counter which has binary storage cells for three bytes, enabling a maximum storage time of about 46603 hours. The operating time counter is preferably formed by the data set stored DA1, DA2, DA3 or DB1, DB2, DB3 of the EEPROMs 11. A data loss which may arise from a defective memory process should be avoided under all circumstances. According to the invention this is provided by the subdivision into a first and at least one second memory region 29, 30. The first memory region contains the first, second and third data stores DA1, DA2, DA3 and the second memory region contains the first, second and third data stores DB1, DB2, DB3.

The reason why a plurality of data stores DA1, DA2, DA3 or DB1, DB2, DB3 are provided instead of respective single data stores is that the maximum number of writing processes in the same data cells of the EEPROMS 11 is limited. After a predetermined number of storage processes with this feature, it is possible to replace one data store by another data store. Just as with the pointers P1, P2, P3 there is here also, preferably starting from a base address, the addition of an offset which preferably is stored in the data offset stores OA, OB. The first data offset store OA contains the offset for the data set stores DA1, DA2, DA3 in the first memory region 29 and the second data offset store OB contains the offset for the data stores PB1, PB2, PB3 in the second memory region 30. The data stores DA1, DA2, DA3 or DB1, DB2, DB3 “wander” to a certain extent through the EEPROM 11.

For further clarification, reference will be made to the first data set store DA1 in the first memory region 29 and the first data set store DBl in the second memory region 30 by way of example only. After the passage of the predetermined time set by the timer 21, the process core 17 adds to the duration represented by a reproduced data set, one unit, for example 1 and stores thus obtained new data set in either the first data set store DA1 or the first data set store DB1 depending upon which memory region 29 or 30 is indicated by the pointer P1 as ineffective. As to the pointers P1, P2, P3, the description below deals exclusively with the pointer P1. The data set which has been reproduced and represents the operating time can be read by the processor core 17 from the data set store DA1 or DB1, whichever has been indicated from the memory regions 29, 30 to be effective by the pointer P1. Preferably a RAM storage 23 for this data set is included in the microcontroller. Similarly, preferably the pointer store 24, the data set offset store 25 and the pointer offset store 26 are also provided as RAM storage.

The first step 53 provided in accordance with the invention stores a data set in the first data set store DA1, DB1 of the memory region 29, 30 indicated to be ineffective is followed by a second step 54 according to the invention in which the pointer P1 is altered to another value which assigns the other memory region 29, 30 as the effective memory region in which the last data set has been stored.

Instead of the two memory regions 29, 30 shown in the illustrated embodiment, further memory regions can be provided. The embodiment with only two memory regions has the advantage that the pointers P1, P2, P3 can be formed as bit pointers which in the simplest case requires only one stored bit that can assume the value 0 or 1.

In a further step, the first and second steps 53 and 54 are cyclically repeated should there be a point in time in which, for example, by opening of switch 14, a false value is registered in the data set store DA1 or DB1, in any case there will be a data set registered from the preceding cycle in a corresponding other data set memory DA1, DB1 which will be available since the bit pointer P1 will still indicate the old effective data set store DA1 to DB1.

In case the storage process which is defective should affect the pointer P1, there will be no effect on the data in the data set store DA1, DB1. In he case of an operating time counter, in 50% of the defects there is a timing error of a cycle. In the embodiment described an error can only last 10 seconds.

After a shutoff of the operating voltage to the current supply line 13 either by the switch 14 or some other event, the reset circuit 12 is active and produces the reset signal 16. Upon an initialization of the microcontroller 10, the pointer P1 is read out in the already described first starting step and the data set from the first data set store DA1, DB1 of the effective memory region 29, 30 is read out in the second starting step 51 and the further program operation can be effected. Optionally, the pointer offset store OP is additionally read out to the extent a plurality of pointers P1, P2, P3 are provided because of the limited writing cycle count of EEPROM 11. In addition, optionally the offset for the data set store is read out from the first or second data offset stores OA, OB to the extent that, instead of only a single data set store DA1, DB1 in the first or second memory regions 29, 30, because of a limited storage cycle count of the EEPROM 11, further data set stores DA2, DA3 are provided in the first memory region 29 and corresponding further data set stores DB2, DB3 are provided in the second memory region 30. The effective data offset store OA or OB is determined by the microcontroller 10 based upon the contents of the pointers P1, P2, P3.

The method according to the invention is especially suitable for use for devices which are to be built into automotive vehicles. In such applications, especially in the shutoff state of the vehicle, only a limited energy quantity is available for operation of the circuit arrangement so that there is a possibility of complete shutdown of the circuit arrangement by means of the switch 14. The method of the invention enables, in spite of the complete shutdown possibilities and the possibilities that data errors will arise in a storage process in EEPROM 11 during the shutdown, a reliable operation of the circuit arrangement. A preferred application in a motor vehicle is in association with an air quality sensor can use an operating time counter for correction of the signals in the short term and in view of long term fluctuations.

1. A method of operating a circuit arrangement which includes a microcontroller (10) and an EEPROM (11), characterized in that in the EEPROM (11) a first memory region (29) with a data set store (DA1, DA2, DA3) and at least a second memory region (30) with a data set store (DB1, DB2, DB3) are provided, in that a third memory region (31) is provided which contains at least one pointer (P1, P2, P3) which indicates the currently effective memory region (29, 30),in that the microcontroller (10) in one step (3) stores a data set in the data set store (DA1, DA2, DA3 or DB1, DB2, DB3) of the ineffective memory region (29, 30) and in a subsequent step (54) alters the pointer (P1, P2, P3) so that the then effective memory region (29, 30) becomes the effective memory region, and in that the two steps (53, 54) are cyclically repeated.

2. The method according to claim 1, characterized in that the microcontroller (10) before the two steps (53, 54) in a first starting step (50) based upon a reset (16) triggered by the reset arrangement (12), reads out the pointer (P1, P2, P3) and in a second starting step (51) the data set from the effective memory region (29, 30) is read out.

3. The method according to claim 1, characterized in that the pointer (P1, P2, P3) is realized as a bit pointer.

4. The method according to claim 1, characterized in that in the second step (54) the bit pointer (P1, P2, P3) is incremented.

5. The method according to claim 1, characterized in that a timer (21) is provided which establishes the timing of the two steps (53, 54).

6. The method according to claim 1, characterized in that the data set store is incremented between the two steps (53, 54).

7. The method according to claim 1, characterized in that the data set store (DA1, DA2, DA3) in the first memory region (29) and the data set store (DB1, DB2, DB3) in the second memory region (30) each have storage steps for three bytes.

8. The method according to claim 1, characterized in that the data set corresponds to an operating duration counter.

9. The use of the method according to claim 1 for devices in a motor vehicle.

10. The use according to claim 9 for an air quality sensor.
